(19) United States
(12) Patent Application Publication
(10) Pub. No.: US 2026/0332658 A1
(43) Pub. Date: Oct. 22, 2026

(54) METHOD AND DEVICE FOR CODING OF VOICE PACKET IN NON-TERRESTRIAL NETWORK

(71) Applicants: HYUNDAI MOTOR COMPANY, Seoul (KR); KIA CORPORATION, Seoul (KR)

(72) Inventors: Young Kil Suh, Hwaseong-si, Gyeonggi-do (KR); Ui Hyun Hong, Hwaseong-si, Gyeonggi-do (KR); Gene Back Hahn, Hwaseong-si, Gyeonggi-do (KR)

(73) Assignees: HYUNDAI MOTOR COMPANY, Seoul (KR); KIA CORPORATION, Seoul (KR)

(21) Appl. No.: 18/995,034

(22) PCT Filed: Sep. 26, 2023
(86) PCT No.: PCT/KR2023/014893

§ 371 Date: Jan. 15, 2025

(30) Foreign Application Priority Data
Sep. 30, 2022 (KR) 10-2022-0125747

(51) Int. Cl. G10L 19/022; H04L 65/70

(52) U.S. Cl. CPC H04L 65/70

(57) ABSTRACT

The present invention may provide a technology of coding of a voice packet in a non-terrestrial network. The present invention may provide a method of a user equipment (UE), the method comprising the steps of: determining whether a packet coding condition for voice packets is satisfied; generating redundancy packets from the voice packets if the packet coding condition is satisfied as a result of the determination; generating transmission blocks including the voice packets and the redundancy packets; and transmitting the transmission blocks to a base station.

### TECHNICAL FIELD

The present disclosure relates to a technique for coding voice packets in a non-terrestrial network, and more particularly, to a technique for coding voice packets in a non-terrestrial network, in which a transmitter generates redundant packets based on adjacent voice packets and transmits the redundant packets to a receiver, so that the receiver uses the redundant packets to recover errored voice packets.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, voice calls or video calls may require extremely low latency. For this reason, voice call services in a non-terrestrial network environment cannot rely on reliability improvements through a hybrid automatic repeat request (HARQ) process. Accordingly, voice call services in a non-terrestrial network environment can ensure transmission reliability through a sufficient number of repeated transmissions. However, some voice data may fail to be decoded due to momentary communication disruptions or insufficient repeated transmissions.

### DISCLOSURE

### Technical Problem

The present disclosure is directed to providing a method and an apparatus for coding voice packets in a non-terrestrial network, in which a transmitter generates redundant packets based on adjacent voice packets and transmits the redundant packets to a receiver, so that the receiver uses the redundant packets to recover errored voice packets.

### Technical Solution

An voice packet coding method performed by a user equipment (UE), in a non-terrestrial network, according to a first exemplary embodiment of the present disclosure for achieving the above-described objective, may comprise: determining whether a packet coding condition for voice packets is satisfied; in response to determining that the packet coding condition is satisfied, generating redundant packets from the voice packets; generating transport blocks including the voice packets and the redundant packets; and transmitting the transport blocks to a base station.

The determining of whether the packet coding condition for voice packets is satisfied may comprise: receiving a coding application indication signal for the voice packets from the base station; and in response to receipt of the coding application indication signal, determining whether the packet coding condition is satisfied.

The coding application indication signal may include a coding application indicator and an application time, the UE may receive the coding application indication signal using one of a radio resource control (RRC) signaling, medium access control (MAC)-control element (CE), and downlink/uplink control information (DCI/UCI), and the UE may determine that the packet coding condition is satisfied when the coding application indicator indicates enabling and the application time arrives.

The method may further comprise: receiving, from the base station, information on a packet coding related parameter table including indicators each indicating a packet coding scheme and a redundancy packet generation periodicity, and the determining of whether the packet coding condition for the voice packets is satisfied may comprise: receiving, from the base station, a coding application indication signal including one indicator from among the indicators; and in response to receipt of the coding application indication signal including the one indicator, determining whether the packet coding condition is satisfied.

The UE may generate the redundancy packets from the voice packets in a packet coding scheme indicated by the one indicator in the packet coding related parameter table, and may determine that the packet coding condition is satisfied when an application time according to a redundancy packet generation periodicity indicated by the one indicator in the packet coding related parameter table arrives.

The packet coding scheme may include information on a range of adjacent voice packets and information on an operation scheme for each of the redundancy packets.

The operation scheme may be a bitwise XOR operation between voice packets.

An voice packet coding method performed by a base station, in a non-terrestrial network, according to a second exemplary embodiment of the present disclosure for achieving the above-described objective, may comprise: transmitting a coding application indication signal for voice packets to a user equipment (UE); receiving, from the UE, first transport blocks respectively including voice packets and cyclical redundancy check (CRC) bits; receiving, from the UE, second transport blocks including redundant packets generated based on the voice packets; detecting at least one first transport block that fails a CRC check among the first transport blocks; and recovering the at least one first transport block using the first transport blocks and the second transport blocks.

The coding application indication signal may include an indicator of whether coding is applied and an application time, and the base station may transmit the coding application indication signal to the UE using one of radio resource control (RRC) signaling, medium access control (MAC)-control element (CE), and downlink/uplink control information (DCI/UCI),

The method may further comprise: generating a packet coding related parameter table including indicators each indicating a packet coding scheme and a redundancy packet generation periodicity; and transmitting the packet coding related parameter table to the UE, wherein the coding application indication signal includes one indicator selected from the indicators.

The packet coding scheme may include information on a range of adjacent voice packets and information on an operation scheme for each of the redundancy packets.

The operation scheme may be a bitwise XOR operation between voice packets.

An voice packet coding apparatus as a user equipment (UE) in a non-terrestrial network, according to a third exemplary embodiment of the present disclosure for achieving the above-described objective, may comprise: determining whether a packet coding condition for voice packets is satisfied; in response to determining that the packet coding condition is satisfied, generating redundant packets from the voice packets; generating transport blocks including the voice packets and the redundant packets; and transmitting the transport blocks to a base station.

In the determining of whether the packet coding condition for voice packets is satisfied, the at least one processor may cause the UE to perform: receiving a coding application indication signal for the voice packets from the base station; and in response to receipt of the coding application indication signal, determining whether the packet coding condition is satisfied.

The at least one processor may cause the UE to perform: receiving, from the base station, information on a packet coding related parameter table including indicators each indicating a packet coding scheme and a redundancy packet generation periodicity, and in the determining of whether the packet coding condition for the voice packets is satisfied, the at least one processor may cause the UE to perform: receiving, from the base station, a coding application indication signal including one indicator from among the indicators; and in response to receipt of the coding application indication signal including the one indicator, determining whether the packet coding condition is satisfied.

The UE may generate the redundancy packets from the voice packets in a packet coding scheme indicated by the one indicator in the packet coding related parameter table, and may determine that the packet coding condition is satisfied when an application time according to a redundancy packet generation periodicity indicated by the one indicator in the packet coding related parameter table arrives.

### Advantageous Effects

According to the present disclosure, a transmitting device can generate redundant packets using adjacent voice packets and transmit the redundant packets to a receiving device. Furthermore, according to the present disclosure, the receiving device can use the redundant packets received from the transmitting device to recover lost voice packets. As described above, according to the present disclosure, the transmitting device can transmit the redundant packets to the receiving device for use in recovering lost voice packets, thereby improving transmission reliability.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a flowchart illustrating a first exemplary embodiment of a method for transmitting voice packets in a communication system.

FIG. 9 is a flowchart illustrating a first exemplary embodiment of a method for receiving voice packets in a communication system.

FIG. 10 is a flowchart illustrating a second exemplary embodiment of a method for transmitting voice packets in a communication system.

FIG. 11 is a conceptual diagram illustrating a first exemplary embodiment of a method for generating TBs, including redundant packets, as shown in FIG. 10.

FIG. 12 is a flowchart illustrating a second exemplary embodiment of a method for receiving voice packets in a communication system.

FIG. 13 is a conceptual diagram illustrating a first exemplary embodiment of a method for recovering lost packets using redundant packets.

FIG. 14 is a diagram illustrating a time delay in the first exemplary embodiment of the method for transmitting voice packets in a communication system.

FIG. 15 is a diagram illustrating a time delay in the second exemplary embodiment of the method for transmitting voice packets in a communication system.

FIG. 16 is a conceptual diagram illustrating the second exemplary embodiment of the method for generating TBs, including redundant packets, as shown in FIG. 10.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re) transmission” may refer to “transmission”, “retransmission”, or “transmission and retransmission”, “(re) configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

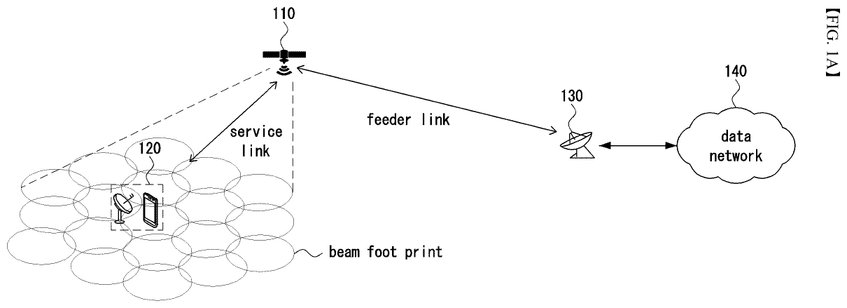

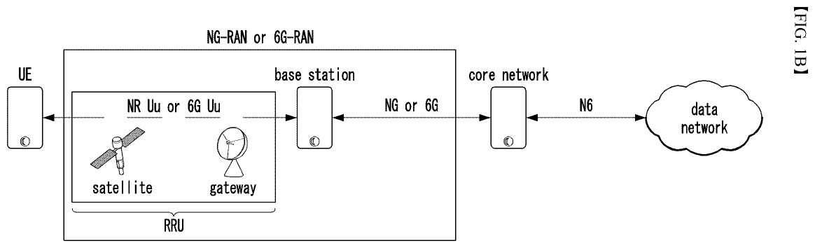

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may be referred to as an NTN payload. The gateway 130 may support a plurality of NTN payloads. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

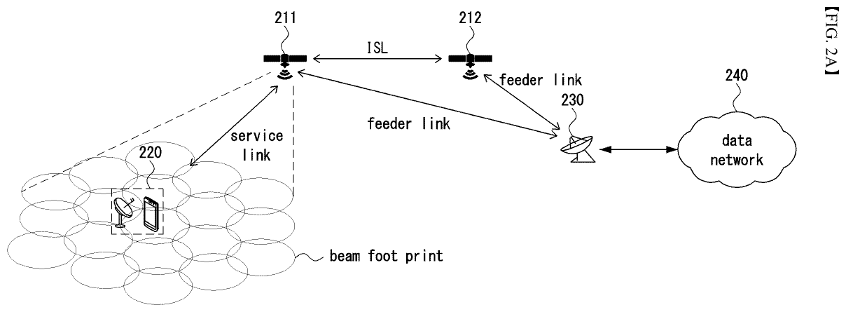

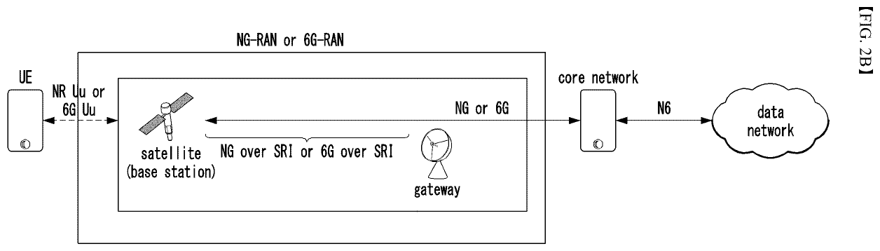

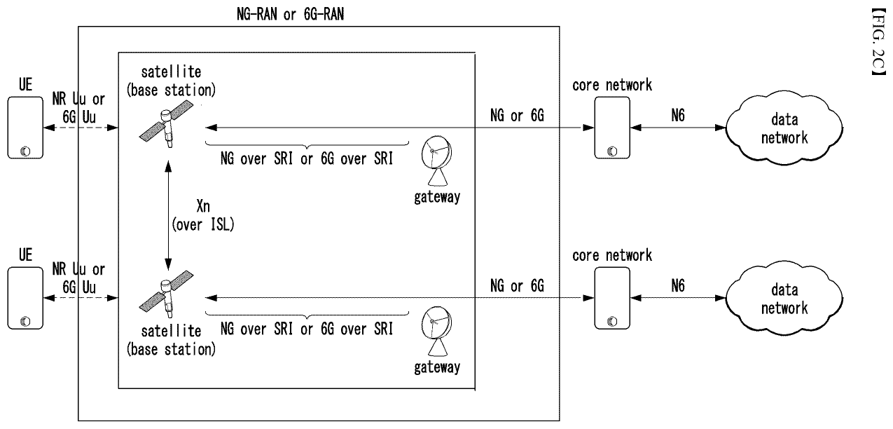

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may be referred to as an NTN payload. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. The base station located on the satellite may be a base station-distributed unit (DU), and a base station-centralized unit (CU) may be located within NG-RAN or 6G-RAN. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

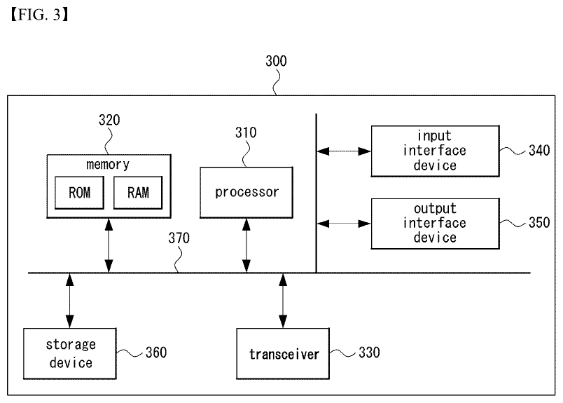

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

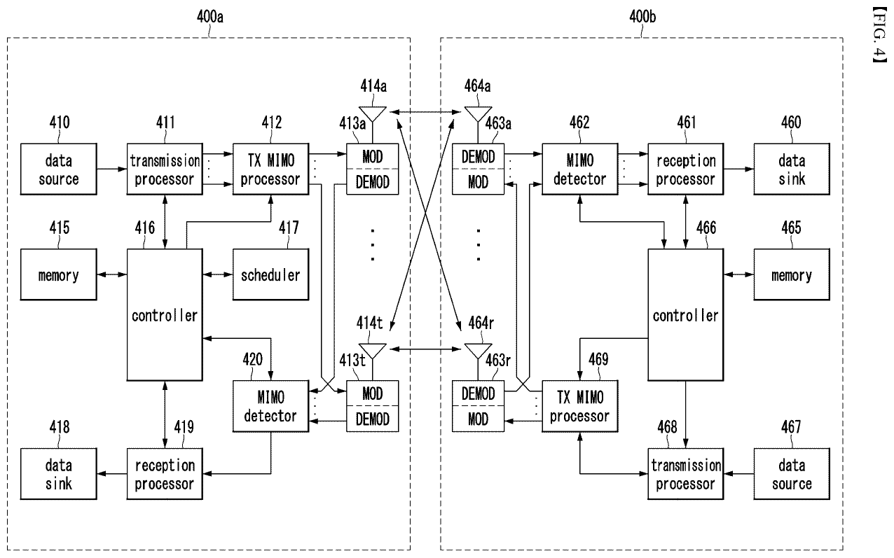

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

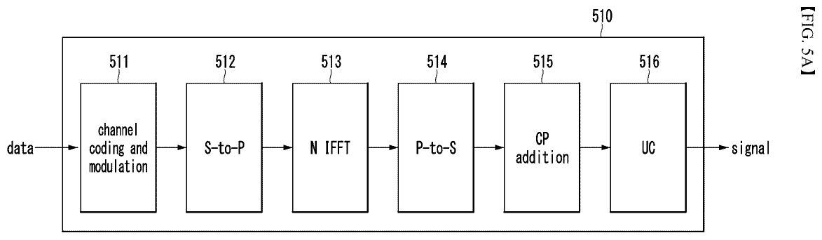

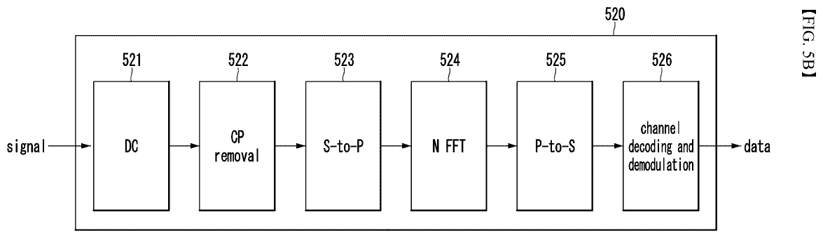

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario A |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’. When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel | 30 MHz for band <6 GHz | |
| bandwidth capability | 1 GHz for band >6 GHz | |
| (service link) | | |
| Maximum distance between | 40,581 km | 1,932 km (altitude of 600 km) |
| satellite and communication | | 3,131 km (altitude of 1,200 km) |
| node (e.g. UE) at the | | |
| minimum elevation angle | | |
| Maximum round trip delay | Scenario A: 541.46 ms | Scenario C: (transparent |
| (RTD) (only propagation | (service and feeder links) | payload: service and feeder |
| delay) | Scenario B: 270.73 ms | links) |
| | (only service link) | −5.77 ms (altitude of 60 0 km) |
| | | −41.77 ms (altitude of 1,200 km) |
| | | Scenario D: (regenerative |
| | | payload: only service link) |
| | | −12.89 ms (altitude of 600 km) |
| | | −20.89 ms (altitude of 1,200 km) |
| Maximum differential delay | 10.3 ms | 3.12 ms (altitude of 600 km) |
| within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | | | Scenario | Scenario |
|---|---|---|---|---|
| | Scenario A | Scenario B | C1-2 | D1-2 |
| Satellite altitude | 35,786 km | | 600 km | |
| Maximum RTD in a | 541.75 ms | 270.57 ms | 28.41 ms | 12.88 ms |
| radio interface | (worst case) | | | |
| between base station | | | | |
| and UE | | | | |
| Minimum RTD in a | 477.14 ms | 238.57 ms | 8 ms | 4 ms |
| radio interface | | | | |
| between base station | | | | |
| and UE | | | | |

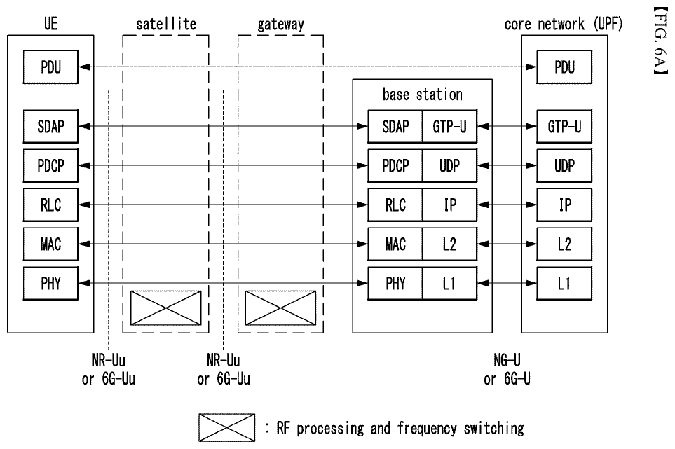

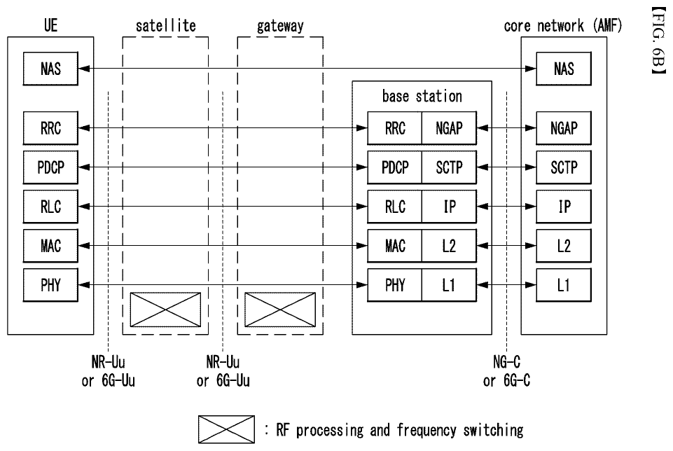

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network. As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

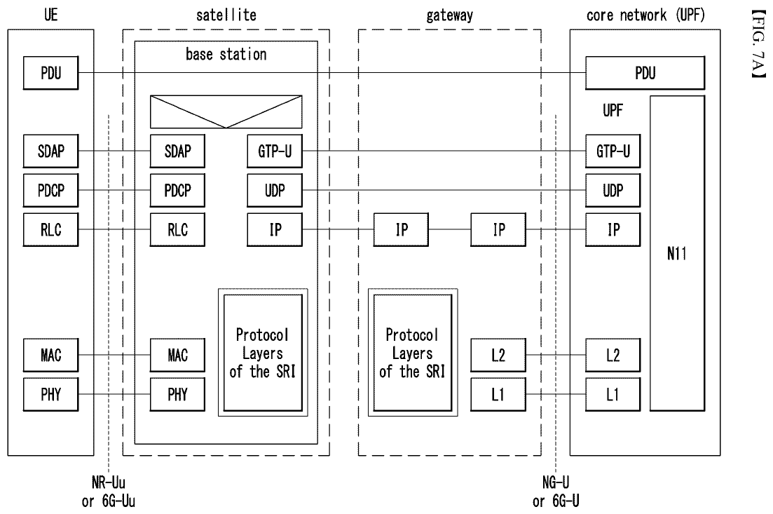

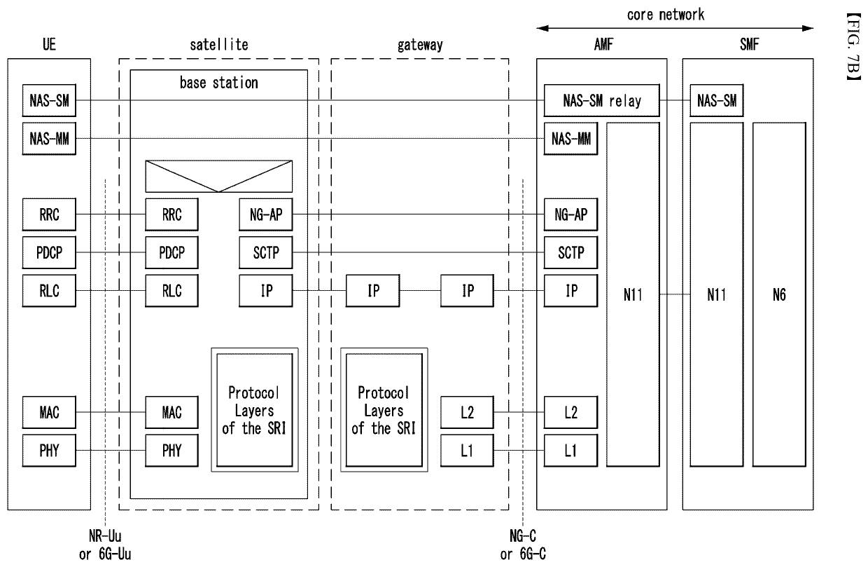

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, a multi-link environment may be configured with a terrestrial network. Here, the multi-link environment may include multi-connectivity and multi-transmission reception point (TRP) environments. In such a multi-link environment, a propagation delay occurring in a wireless channel of each link may be less than 0.1 millisecond. On the other hand, the multi-link environment may include a non-terrestrial network. In such a multi-link environment, a propagation delay occurring in a wireless channel of each link may range from several milliseconds to several hundred milliseconds. Accordingly, feedback transmission and retransmission for a hybrid automatic repeat request (HARQ) process in a network that includes a non-terrestrial network may require a very large amount of time.

Meanwhile, voice calls or video calls may be applications that require real-time bidirectional communication. Such voice calls or video calls may require extremely low latency. In this reason, voice call services in a non-terrestrial network environment may not benefit from improved reliability through a HARQ process. Accordingly, voice call services in the non-terrestrial network environment may ensure transmission reliability through a sufficient number of repeated transmissions. However, some voice data may fail to be decoded due to momentary communication interruptions or insufficient repeated transmissions.

Meanwhile, packet aggregation (or packet combining) may refer to aggregation of multiple packets to generate a single packet. Such packet aggregation may be discussed in transmission scenarios for NR NTN voice over internet protocol (VOIP).

Table 4 shows delays and remaining time margins according to altitudes of NTN satellites.

TABLE 4

| | | | MEO | |
|---|---|---|---|---|
| | LEO (altitude | LEO (altitude | (altitude of | |
| Delay [ms] | of 600 km) | of 1200 km) | 10000 km) | GEO |
| Maximum E2E | 200 ms | | | |
| delay | | | | |
| Transmission delay | 35 ms | | | |
| Reception delay | 45 ms | | | |
| Minimum RTD in a | 28.408 ms | 51.66 ms | 190.384 ms | 544.74 ms |
| wireless interface | | | | |
| between base | | | | |
| station and UE | | | | |
| Remaining time | 91.592 ms | 68.34 ms | −70.384 ms | −424.74 ms |
| margin | | | | |

As shown in Table 4, the remaining time margin may vary depending on the altitude of the satellite in the non-terrestrial network. The larger the remaining time margin, the more packets a base station or terminal may collect and process. Meanwhile, 3GPP-Release 17 may allow the number of repetitions for physical uplink shared channel (PUSCH) to be one of {1, 2, 4, 8, 12, 16, 24, 32}. Accordingly, up to 32 repetitions of PUSCH may be possible. For a voice call, the terminal may periodically transmit voice packets each composed of a fixed amount of bits. For example, an adaptive multi-rate (AMR) voice codec of the terminal may deliver a transport block (TB) composed of 184 bits from a layer 2 (L2) to a layer 1 (L1) every milliseconds. Then, the L1 of the terminal may append cyclical redundancy check (CRC) bits to the transport block. Additionally, the L1 of the terminal may perform low density parity check (LDPC) encoding on the transport block with the CRC bits. Subsequently, the L1 of the terminal may transmit the LDPC-encoded transport block with the CRC bits.

As described above, for a voice call, the terminal may transmit voice packets generated periodically for each cycle. Additionally, for the voice call, the terminal may transmit periodically generated voice packets independently. Conversely, in a coding method for voice packets in a non-terrestrial network according to the present disclosure, the terminal may buffer and encode several generated voice packets. As a result, a transmission delay of the voice packets may increase. However, a transmission reliability of the data may improve. In other words, a packet loss rate may improve.

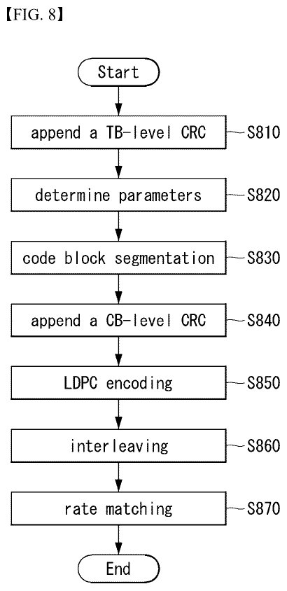

FIG. 8 is a flowchart illustrating a first exemplary embodiment of a method for transmitting voice packets in a communication system.

As shown in FIG. 8, a transmitting device may append a TB-level CRC to voice packets generated every 20 ms, for example (S810). In this case, the voice packet may be configured with a transport block (TB). The transport block may have a transport block size (TBS) of A bits. Here, A may be a positive real number. Furthermore, the transmitting device may append a CRC of C1 bits to the transport block. C1 may represent a TB-level CRC length, which may, for example, be 24, 16, or another value less than 24.

The transmitting device may determine segmentation parameters for TB processing (S820). The parameters may include the number of code block (CB) segments, the length of each CB segment, one or more LDPC code lifting sizes, and a mother code rate of the LDPC code. Regarding the number of CB segments, a TB with a total size of (A+C1), which is obtained by adding the TBS of A bits and the CRC length C1, may be divided into multiple segments. Regarding the length of each CB segment and the number of padding bits, padding bits periodically repeated from information bits may be zeros, a known sequence, or a subset of a known sequence.

Subsequently, the transmitting device may perform CB segmentation to generate multiple CBs (S830). For example, the transmitting device may pad zeros to the TB and segment the TB accordingly. Furthermore, the transmitting device may append a CB-level CRC to each of the multiple CBs (S840). Then, the transmitting device may perform LDPC encoding (S850). For example, the transmitting device may perform LDPC encoding by encoding each segmented CB using a determined mother LDPC code parity-check matrix. As a result of the LDPC encoding, an encoded block may be provided.

The transmitting device may perform interleaving on the encoded block (S860). Then, the transmitting device may perform rate matching on the interleaved and encoded block (S870). For example, the transmitting device may perform puncturing or repetition based on a circular buffer to match a desired code rate. The transmitting device may modulate the rate-matched packet and transmit it to a receiving device.

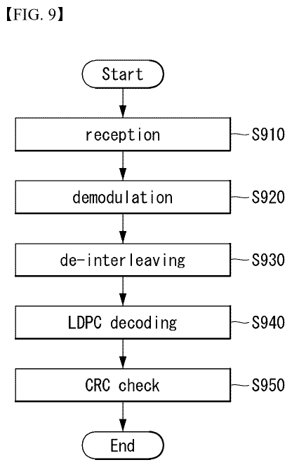

FIG. 9 is a flowchart illustrating a first exemplary embodiment of a method for receiving voice packets in a communication system.

As shown in FIG. 9, the receiving device may receive a signal from the transmitting device (S910) and demodulate the received signal (S920). The receiving device may perform demodulation using a demodulation scheme corresponding to the modulation scheme used by the transmitting device. As a result, encoded bits included in the received signal may be obtained. Subsequently, the receiving device may perform de-interleaving on the encoded bits (S930). In this case, the receiving device may perform the de-interleaving process using a de-interleaving scheme corresponding to the interleaving scheme used by the transmitting device.

The receiving device may then combine encoded bits of the same packet previously stored in a buffer memory with the currently received encoded bits. Then, the receiving device may perform LDPC decoding on the encoded bits (S940). Subsequently, the receiving device may extract CRC bits from the LDPC-decoded information bits on a packet basis, and perform a CRC check using the extracted CRC bits to determine whether the packet contains errors (S950). If the CRC check determines that the packet does not contain errors, the receiving device may output the information bits in the packet to a higher layer.

Meanwhile, the transmitting device in FIG. 8 and the receiving device in FIG. 9 may use LDPC codes and CRC techniques to overcome data transmission errors occurring during the transmission process of voice packets. In other words, an LDPC encoder of the transmitting device and an LDPC decoder of the receiving device may function to minimize a bit-level error rate occurring during the transmission process. Additionally, the transmitting device and the receiving device may determine whether each TB (or CB) contains errors using the CRC. Through this process, the receiving device may detect a TB with errors. Furthermore, the receiving device may receive additional signals for the same data from the transmitting device through a HARQ procedure for the TB identified through the CRC process. As a result, the transmission reliability of the data may improve.

However, in the non-terrestrial network, voice packets may not utilize retransmissions through a HARQ procedure. This may be because voice calls may be highly sensitive to requirements for an end-to-end (E2E) delay, and a propagation delay in the non-terrestrial network may be significantly large. Therefore, in the non-terrestrial network, it may be difficult for voice packets to achieve high transmission reliability through HARQ.

Meanwhile, voice calls may be applications highly dependent on uplink (UL) usage. In this case, a transmission power of the terminal may have limitations. Consequently, the transmission reliability of voice packets in the non-terrestrial network may be lower than that of general data transmission. Thus, in the non-terrestrial network, the receiving device may frequently fail to receive TBs.

To address this problem, in the present disclosure, the transmitting device may generate redundant packets based on a correlation between packets and transmit the generated redundant packets to the receiving device. Then, the receiving device may receive the redundant packets from the transmitting device. Furthermore, the receiving device may recover a TB with errors using the received redundant packets. For such processing, the transmitting device may include a packet coding block. Here, the packet coding block may include a packet aggregation unit. The packet coding block may receive multiple packets from another block of the transmitting device. In this case, the multiple packets may have the same amount of bits. Additionally, the packets may be voice packets. These voice packets may, for example, be generated every 20 milliseconds.

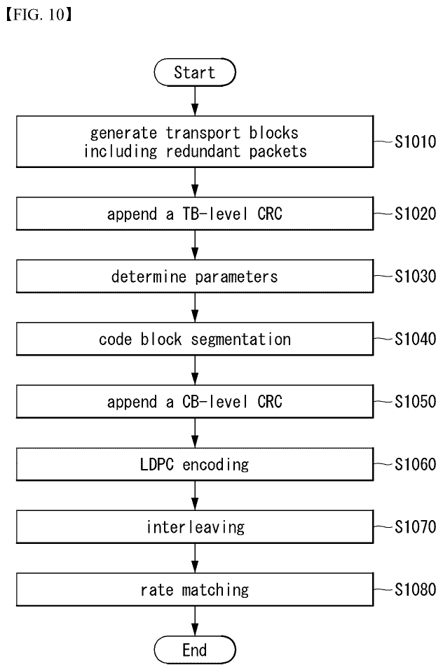

FIG. 10 is a flowchart illustrating a second exemplary embodiment of a method for transmitting voice packets in a communication system.

As shown in FIG. 10, the packet coding block of the transmitting device may receive multiple voice packets generated every 20 ms, for example, from another block. The packet coding block may then generate TBs, including redundant packets, using the multiple voice packets (S1010).

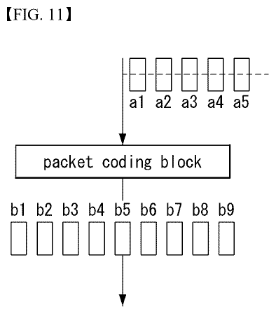

FIG. 11 is a conceptual diagram illustrating a first exemplary embodiment of a method for generating TBs, including redundant packets, as shown in FIG. 10.

As shown in FIG. 11, the packet coding block may receive six voice packets (i.e. a1 to a6), for example, from another block. The packet coding block may generate a first TB b1 using the first voice packet a1. Then, the packet coding block may generate a first redundant packet using the first voice packet a1 and the second voice packet a2 to form a second TB b2. For example, the packet coding block may perform a bitwise XOR operation on the first voice packet and the second voice packet to generate the first redundant packet and form the second transport block. Here, the bitwise XOR operation may be denoted as ⊕. Subsequently, the packet coding block may generate a third transport block b3 using the second voice packet a2. Then, the packet coding block may generate a second redundant packet using the second voice packet a2 and the third voice packet a3 to form a fourth transport block b4. For example, the packet coding block may perform a bitwise XOR operation on the second voice packet and the third voice packet to generate the second redundant packet and form the fourth transport block. In the above-described manner, the packet coding block may generate a fifth transport block b5 to a ninth transport block b9. The TBs output from the packet coding block may be classified into two types: voice TBs, such as b1 and b3, which directly include the voice packets received from another block, and redundant TBs, such as b2 and b4, which include redundant packets obtained by aggregating multiple voice packets.

Referring again to FIG. 10, the transmitting device may transmit each TB to the receiving device through a physical layer procedure. In other words, the transmitting device may append a TB-level CRC to each TB (S1020). The TB may have a TBS of A bits. Here, A may be a positive real number. Furthermore, the transmitting device may append a CRC of C1 bits to the TB. C1 may represent a TB-level CRC length, which may, for example, be 24, 16, or another value less than 24.

The transmitting device may determine segmentation parameters for TB processing (S1030). The parameters may include the number of CB segments, the length of each CB segment, one or more LDPC code lifting sizes, and a mother code rate of the LDPC code. Regarding the number of CB segments, the TB with a total size of (A+C1), which is obtained by adding the TBS of A bits and the CRC length C1, may be divided into multiple segments. Regarding the length of each CB segment and the number of padding bits, padding bits periodically repeated from information bits may be zeros, a known sequence, or a subset of a known sequence.

Subsequently, the transmitting device may perform CB segmentation to generate multiple CBs (S1040). For example, the transmitting device may pad zeros to the TB and segment the TB accordingly. The transmitting device may then append a CB-level CRC to each of the multiple CBs (S1050). Then, the transmitting device may perform LDPC encoding (S1060). For example, the transmitting device may perform LDPC encoding by encoding each segmented CB using a determined mother LDPC code parity-check matrix. As a result of the LDPC encoding, an encoded block may be generated.

The transmitting device may perform interleaving on the encoded block (S1070). Furthermore, the transmitting device may perform rate matching on the interleaved encoded block (S1080). For example, the transmitting device may perform puncturing or repetition based on a circular buffer to match a desired code rate. The transmitting device may modulate the rate-matched packet and transmit it to the receiving device. In this case, the transmitting device may sequentially transmit [b1 b2 b3 b4 b5 b6 b7 b8 b9] to the receiving device through the above-described process. Alternatively, the transmitting device may change the transmission order of the voice packets and redundant packets, transmitting them as [b1 b3 b2 b5 b4 b7 b6 b9 b8]. In this case, some TBs may experience CRC failures. For example, b3, b6, and b7 may be lost. Here, b3 and b7 correspond to TBs associated with a2 and a4, respectively, which may require recovery. Specifically, a2 and b3 may be obtained through the operation b1⊕b2, and a4 and b7 may be obtained through the operation b8⊕b9.

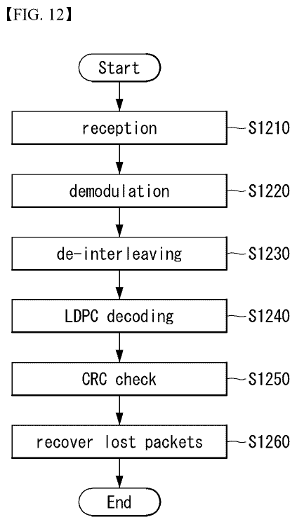

FIG. 12 is a flowchart illustrating a second exemplary embodiment of a method for receiving voice packets in a communication system.

As shown in FIG. 12, the receiving device may receive a signal from the transmitting device (S1210) and demodulate the received signal (S1220). If the transmitting device sequentially transmits [b1 b2 b3 b4 b5 b6 b7 b8 b9], the receiving device may sequentially receive [b1 b2 b3 b4 b5 b6 b7 b8 b9]. Alternatively, if the transmitting device changes the transmission order of voice packets and redundant packets, transmitting them as [b1 b3 b2 b5 b4 b7 b6 b9 b8], the receiving device may receive them in the same changed order as [b1 b3 b2 b5 b4 b7 b6 b9 b8].

The receiving device may demodulate each TB received from the transmitting device using a demodulation scheme corresponding to the modulation scheme used by the transmitting device. As a result, encoded bits included in the received signal may be obtained. Subsequently, the receiving device may perform de-interleaving on the encoded bits (S1230). In this case, the receiving device may perform de-interleaving using a de-interleaving scheme corresponding to the interleaving scheme used by the transmitting device.

The receiving device may combine encoded bits of the same packet previously stored in a buffer memory with the currently received encoded bits. Subsequently, the receiving device may perform LDPC decoding on the encoded bits (S1240). Then, the receiving device may extract CRC bits on a packet basis from the LDPC-decoded information bits and perform a CRC check using the extracted CRC bits to determine whether the packet contains errors (S1250). If the CRC check determines that a packet does not contain errors, the receiving device may output the information bits in the packet to a higher layer. In this case, some TBs may experience CRC failures. Accordingly, the receiving device may restore lost packets using redundant packets (S1260).

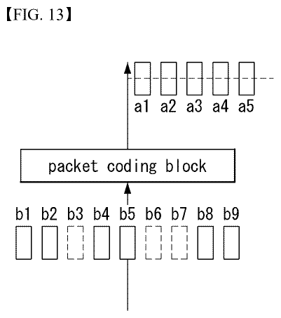

FIG. 13 is a conceptual diagram illustrating a first exemplary embodiment of a method for recovering lost packets using redundant packets.

As shown in FIGS. 13, b3, b6, and b7 may be lost. Here, b3 and b7 correspond to TBs associated with a2 and a4, respectively, which may require recovery. Specifically, a2 and b3 may be obtained through the operation b1⊕b2, and a4 and b7 may be obtained through the operation b8⊕b9.

Meanwhile, to apply the voice packet coding method according to the present disclosure, the transmitting device may buffer a certain amount of recently input voice packets. For example, referring to FIG. 11, the transmitting device may buffer a1 and a2 to generate b1 using a1 and a2. Additionally, the transmitting device may buffer a4 and a5 to generate b9 using a4 and a5. Referring to FIG. 13, the receiving device may need to wait for the reception of b8 and b9 to restore b7, potentially requiring additional delay time.

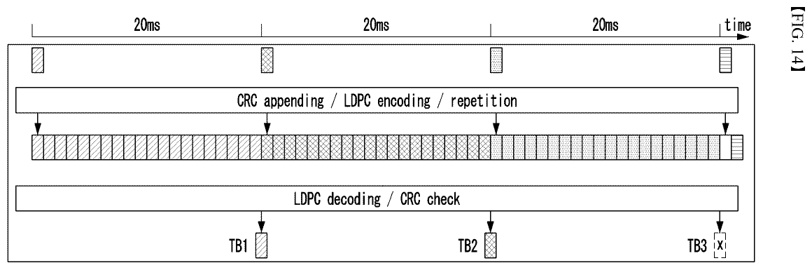

FIG. 14 is a diagram illustrating a time delay in the first exemplary embodiment of the method for transmitting voice packets in a communication system.

As shown in FIG. 14, the transmitting device may append a CRC to each of voice packets generated every 20 ms. The transmitting device may then perform LDPC encoding on the CRC-attached voice packet to generate a codeword. The transmitting device may repeatedly transmit the generated codeword. Due to this repeated transmission, the receiving device may wait until the last slot to decode the repeatedly received TB, resulting in a delay caused by the repeated transmission.

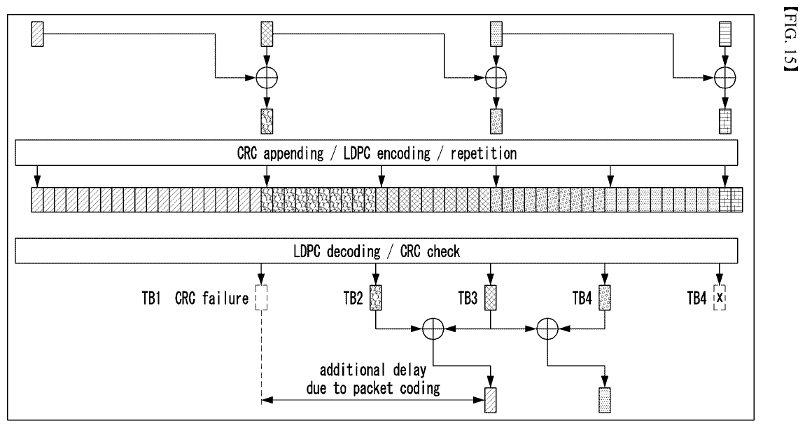

FIG. 15 is a diagram illustrating a time delay in the second exemplary embodiment of the method for transmitting voice packets in a communication system. As shown in FIG. 15, the transmitting device may process packet coding at a top layer of L1, i.e. the physical layer. However, instead of processing packet coding at the top layer of L1, the transmitting device may process it at a bottom layer of L2. The transmitting device may repeatedly transmit TBs output by the packet coding. If a TB1 fails a CRC check, the receiving device may use a TB2 and TB3 to recover the TB1. Thus, the receiving device may need to wait for LDPC decoding and CRC results of the TB3, which may introduce additional delay caused by the packet coding technique. For example, because the packet coding is performed between two adjacent voice packets, an additional delay of 20 ms may occur.

According to FIGS. 11 and 12, the transmitting device may generate a redundant transport block from two packets. The transmitting device may alternately transmit TBs and redundant TBs generated from voice packets. In this case, there may be various methods for generating redundant TBs. For example, the transmitting device may generate a redundant TB by performing a bitwise XOR operation on the most recently generated voice packet and a voice packet generated n cycles earlier. This scheme may be expressed in the present disclosure by a polynomial p(z)=1+zⁿ. Here, ‘1’ in p(z) may represent the most recently generated voice packet, and zⁿ may represent a voice packet generated n cycles earlier (e.g. 20n milliseconds earlier) by the transmitting device. For example, a polynomial p(z)=1+z² may represent generating a redundant TB using the most recently generated voice packet and a voice packet generated 40 ms earlier.

Similarly, a polynomial p(z)=1+z may represent generating a redundant TB using the most recently generated voice packet and a voice packet generated one cycle earlier. A polynomial p(z)=1+z+z² may represent generating a redundant TB using the most recently generated voice packet, a voice packet generated one cycle earlier, and a voice packet generated two cycles earlier.

For a given code structure (redundant packet generation polynomial p(z)), a delay required to recover a TB may vary depending on a location of a CRC failure. For example, in FIG. 15, the receiving device may recover lost TB1 and TB5. In this case, the receiving device may recover TB1 using TB2 and TB3 and may need to wait for the reception of TB3. Additionally, the receiving device may recover TB5 using TB3 and TB4 without incurring additional delay. However, considering the characteristics of VOIP applications, in order to sequentially and continuously play 20 ms voice data, a scenario with the largest additional delay has the greatest impact on end-to-end delay.

The additional delay caused by the proposed coding method in the present disclosure may be calculated from a degree of the highest-order term in the polynomial p(z). If packet coding is not used, p(z) may be considered as 1, in which case no additional delay may occur. On the other hand, when p(z)=1+z and p(z)=1+z+z², additional delays of 20 ms and 40 ms, respectively, may occur.

Currently, in NR VOIP, an end-to-end delay may be required to meet 200 ms. In the NTN environment of low-earth orbit satellites, this requirement may be satisfied even with an assumed additional delay of 20 ms caused by packet coding. If a distance between the terminal, satellite, and ground station is not large, packet coding with a delay greater than 20 ms may be used.

Meanwhile, the base station may determine whether to apply packet coding using channel information of the terminal. The base station may also decide when to start applying packet coding. In this case, the base station may notify the terminal of whether to apply packet coding and an application time by using an indicator indicating whether to apply packet coding and an indicator indicating the application time.

For example, the indicator representing whether to apply packet coding may be denoted as A. As an example, if A is set to ‘0’, it may indicate that packet coding is not applied. Conversely, if A is set to ‘1’, it may indicate that packet coding is applied. In addition, the indicator representing the application time may be denoted as B. As an example, B set to 3 may indicate that packet coding proposed in the present disclosure is to be applied starting from generation of the fourth (i.e. (B+1)-th) voice packet based on a downlink slot in which the indicator is transmitted. Table 5 below illustrates the indicators whether to apply packing coding and the application time of the packet coding.

TABLE 5

| | |
|---|---|
| Whether to apply packet coding | A = 0: Disable |
| | A = 1: Enable |
| Application time | B |

The base station may perform signaling for whether to apply packet coding and application time for both the uplink and the downlink, respectively. For example, the base station may disable packet coding for the downlink while enabling packet coding for the uplink. The base station may also separately set the application times for the uplink and the downlink. Meanwhile, if the base station instructs the terminal to apply packet coding, it may also inform the terminal of a packet coding scheme to be used. In this case, the base station may transmit to the terminal an indicator that specifies the degree of the highest-order term and the coefficient of the respective terms in the polynomial p(z). For example, the degree of the highest-order term may be denoted as C and the coefficients of the respective terms may be represented as a matrix D. If C is set to 1, it may indicate that the degree of the highest-order term is 1. Similarly, if C is set to 2, it may indicate that the degree of the highest-order term is 2. The matrix D may represent the coefficients of the terms. For example, when p(z)=1+z+z², [D0,D1,D2] may be expressed as [1,1,1]. Similarly, when p(z)=1+z², [D0,D1,D2] may be expressed as [1,0,1]. Here, the constant term 1 represents that the most recently generated voice packet is used in the generation of the redundant packet and is always assumed to be 1. Therefore, D0 may be considered optional. Similarly, since the degree of p(z) has already been conveyed as the value C, the coefficient of the highest-order term may also be assumed to be 1. Thus, the coefficients of the constant term and the highest-order term may be omitted.

Alternatively, the transmitting device may predefine the value of C (the degree of p(z)) as a specific natural number. In this case, the base station may omit the transmission of C. Table 6 below may illustrate a scheme for indicating the highest-order term and the terms used, where E may represent a parity generation periodicity.

TABLE 6

| | |
|---|---|
| Code structure: degree of p(z) | C |
| Code structure: coefficients of | D0 D1 D2 . . . DA |
| respective terms in p(z) | |
| Parity generation periodicity | E |

The base station may configure the parity generation periodicity to the terminal. Accordingly, the base station may control the amount of redundant packets generated by the terminal. For example, the base station may set E to 1 and deliver this value to the terminal. When E is set to 1, the terminal may generate redundant packets through p(z) every 20 ms or whenever a voice packet is generated. Similarly, if E is greater than 1, it may indicate that redundant packets are generated every E-th voice packet generation.

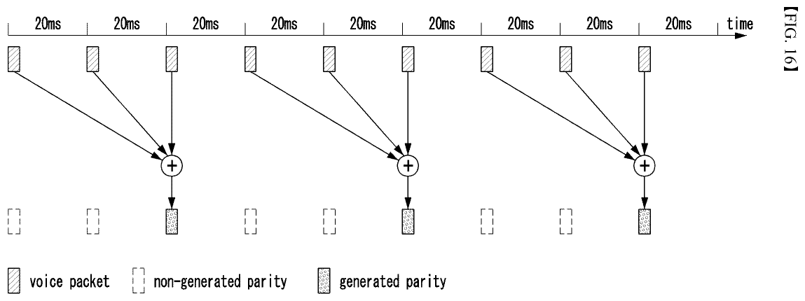

FIG. 16 is a conceptual diagram illustrating the second exemplary embodiment of the method for generating TBs, including redundant packets, as shown in FIG. 10. As shown in FIG. 16, a polynomial p(z) referenced by the packet coding block may be 1+z+z², and the redundant packet generation periodicity may be 3. As the parity generation periodicity increases, the number of TBs to be transmitted may decrease. Consequently, the number of repetitions for each TB may increase.

Meanwhile, to reduce the number of bits required for signaling packet coding information, the base station may consider a packet coding parameter table like Table 7. In Table 7, the base station may predefine code-related parameters corresponding to a single indicator. The base station may deliver the packet coding parameter table information to the terminal. Subsequently, the base station may notify the terminal of a code structure and a parity generation period by transmitting an indicator. The predefined parameter table may be provided to the terminal in advance through RRC configuration/reconfiguration or other means. Alternatively, an administrator may store the table in the terminal in advance for use.

TABLE 7

| Indicator | 0000 | 0001 | 0010 | 0011 | . . . |
|---|---|---|---|---|---|
| Code structure: | 1 | 1 | 2 | 2 | . . . |
| degree of p(z) | | | | | |
| Code structure: | [D0 D1] = | [D0 D1] = | [D0 D1 D2] = | [D0 D1 D2] = | . . . |
| coefficients of | [1 1] | [1 1] | [1 1 1] | [1 0 1] | |
| respective terms in | | | | | |
| p(z) | | | | | |
| Parity generation | 1 | 2 | 3 | 1 | . . . |
| periodicity | | | | | |

The packet coding-related indicators in the present disclosure may be fully or partially configured or updated via higher-layer signaling such as RRC signaling or Medium Access Control-Control Element (MAC-CE), or through Downlink/Upload Control Information (DCI/UCI). These packet coding-related indicators may include information such as whether packet coding is applied, the application time of packet coding, the code structure, and the parity generation periodicity.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
determining whether a packet coding condition for voice packets is satisfied;
in response to determining that the packet coding condition is satisfied, generating redundant packets from the voice packets;
generating transport blocks including the voice packets and the redundant packets; and
transmitting the transport blocks to a base station.

2. The method according to claim 1, wherein the determining of whether the packet coding condition for voice packets is satisfied comprises:
receiving a coding application indication signal for the voice packets from the base station; and
in response to receipt of the coding application indication signal, determining whether the packet coding condition is satisfied.

3. The method according to claim 2, wherein the coding application indication signal includes a coding application indicator and an application time, the UE receives the coding application indication signal using one of a radio resource control (RRC) signaling, medium access control (MAC)-control element (CE), and downlink/uplink control information (DCI/UCI), and the UE determines that the packet coding condition is satisfied when the coding application indicator indicates enabling and the application time arrives.

4. The method according to claim 1, further comprising: receiving, from the base station, information on a packet coding related parameter table including indicators each indicating a packet coding scheme and a redundancy packet generation periodicity, and the determining of whether the packet coding condition for the voice packets is satisfied comprises:
receiving, from the base station, a coding application indication signal including one indicator from among the indicators; and
in response to receipt of the coding application indication signal including the one indicator, determining whether the packet coding condition is satisfied.

5. The method according to claim 4, wherein the UE generates the redundancy packets from the voice packets in a packet coding scheme indicated by the one indicator in the packet coding related parameter table, and determines that the packet coding condition is satisfied when an application time according to a redundancy packet generation periodicity indicated by the one indicator in the packet coding related parameter table arrives.

6. The method according to claim 4, wherein the packet coding scheme includes information on a range of adjacent voice packets and information on an operation scheme for each of the redundancy packets.

7. The method according to claim 6, wherein the operation scheme is a bitwise XOR operation between voice packets.

8. A method of a base station, comprising:
transmitting a coding application indication signal for voice packets to a user equipment (UE);
receiving, from the UE, first transport blocks respectively including voice packets and cyclical redundancy check (CRC) bits;
receiving, from the UE, second transport blocks including redundant packets generated based on the voice packets;
detecting at least one first transport block that fails a CRC check among the first transport blocks; and
recovering the at least one first transport block using the first transport blocks and the second transport blocks.

9. The method according to claim 8, wherein the coding application indication signal includes an indicator of whether coding is applied and an application time, and the base station transmits the coding application indication signal to the UE using one of radio resource control (RRC) signaling, medium access control (MAC)-control element (CE), and downlink/uplink control information (DCI/UCI),

10. The method according to claim 8, further comprising:
generating a packet coding related parameter table including indicators each indicating a packet coding scheme and a redundancy packet generation periodicity; and
transmitting the packet coding related parameter table to the UE,
wherein the coding application indication signal includes one indicator selected from the indicators.

11. The method according to claim 10, wherein the packet coding scheme includes information on a range of adjacent voice packets and information on an operation scheme for each of the redundancy packets.

12. The method according to claim 10, wherein the operation scheme is a bitwise XOR operation between voice packets.

13. A user equipment (UE) comprising at least one processor, wherein the at least one processor causes the UE to perform:
determining whether a packet coding condition for voice packets is satisfied;
in response to determining that the packet coding condition is satisfied, generating redundant packets from the voice packets;
generating transport blocks including the voice packets and the redundant packets; and
transmitting the transport blocks to a base station.

14. The UE according to claim 13, wherein in the determining of whether the packet coding condition for voice packets is satisfied, the at least one processor causes the UE to perform:
receiving a coding application indication signal for the voice packets from the base station; and
in response to receipt of the coding application indication signal, determining whether the packet coding condition is satisfied.

15. The UE according to claim 13, wherein the at least one processor causes the UE to perform: receiving, from the base station, information on a packet coding related parameter table including indicators each indicating a packet coding scheme and a redundancy packet generation periodicity, and in the determining of whether the packet coding condition for the voice packets is satisfied, the at least one processor causes the UE to perform:
receiving, from the base station, a coding application indication signal including one indicator from among the indicators; and
in response to receipt of the coding application indication signal including the one indicator, determining whether the packet coding condition is satisfied.

16. The UE according to claim 15, wherein the UE generates the redundancy packets from the voice packets in a packet coding scheme indicated by the one indicator in the packet coding related parameter table, and determines that the packet coding condition is satisfied when an application time according to a redundancy packet generation periodicity indicated by the one indicator in the packet coding related parameter table arrives.
